(19) United States
(12) Patent Application Publication
(10) Pub. No.: US 2003/0197584 A1
(43) Pub. Date: Oct. 23, 2003

(54) Ignition apparatus having spark plug connection which supplies isolation between plug and apparatus

(76) Inventors: Dean M. Ford, Yorktown, IN (US); Diane E. Hageman, Fishers (IN)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/124,126

(22) Filed: Apr. 17, 2002

(51) Int. Cl. H01F 27/02

(52) U.S. Cl. 336/96

(57) ABSTRACT

An ignition coil has a high voltage connector for connecting a high voltage output to a spark plug. The connector includes a terminal having a base, an annular sidewall axially extending from the base defining an interior, and a circumferentially-extending groove on an interior surface of the sidewall. A contact assembly of a spring clip sandwiched between a pair of wave washers is disposed in the groove, with a spring contact being disposed between the contact assembly and the base. The spring rates of the wave washers and the contact spring are low relative to the mass of the ignition coil, resulting in a low natural frequency for the overall combination. The connector provides vibration isolation between the coil and the spark plug, to thereby allow omitting the conventional connection of the coil to the engine via a bolt through a bolt hole on the coil case.

### BACKGROUND OF THE INVENTION

1. Technical Field

The present invention relates generally to an ignition apparatus having a high voltage connection that provides isolation between the ignition apparatus and a spark plug.

2. Discussion of the Background Art

It is known to provide an ignition coil having a relatively slender profile configured to be disposed in a spark plug well and mounted directly to a spark plug, referred to as a “pencil” coil, as seen be reference to U.S. Pat. No. 6,114,935 entitled “IGNITION COIL HAVING COIL CASE,” issued to Oosuka et al. (“Oosuka”). The ignition coil of Oosuka includes a case that has a flange with a bolt hole for attaching the ignition coil to an internal combustion engine. Oosuka further discloses the use of a helical spring for making the high voltage connection between the ignition coil and the spark plug. The arrangement of Oosuka for connecting the coil to the engine and the coil to the spark plug is conventional, and may be characterized as having a relatively high natural frequency (“rigid”). That is, engine vibration is very directly coupled to the ignition coil, which can cause unwanted resonances. Also, it may be observed that use of the connection bolt(s) (or other fasteners) increases mass, cost and installation complexity. In view of these problems, it has been suggested to provide an ignition coil without a bolt hole for a connection bolt for fastening the coil to the engine. However, conventional high voltage connections between the ignition coil and the spark plug, such as seen in Oosuka, would be unable to provide a suitably secure connection (both electrically and mechanically) between the ignition coil and the spark plug, absent such connecting bolts (i.e., the helical spring contact relies on the coil being mechanically connected to the engine). It is desirable, therefore, to have a strong mechanical and electrical connection between the ignition coil and the spark plug, to ensure uninterrupted operation. A challenge, however, exists in realizing such a design inasmuch as in some cases, vibration of the spark plug may be undesirably coupled to the ignition coil when conventional connection approaches are utilized.

There is therefore a need to provide an ignition apparatus with a spark plug connection that minimizes or eliminates one or more of the problems set forth above.

### SUMMARY OF THE INVENTION

An object of the present invention is to provide a solution to one or more of the problems set forth above. One advantage of the present invention is that it provides a strong mechanical and electrical connection between an ignition apparatus and a spark plug, while dynamically isolating the ignition apparatus from the vibration of the spark plug. Another advantage of the present invention is that it allows an ignition apparatus to be configured without a bolt connection hole or the like in the case.

An ignition apparatus according to the present invention includes a transformer portion and a connector portion. The transformer portion is configured to be coupled to a power source and is arranged to produce a spark voltage on an output thereof. The connector portion is configured to couple the spark voltage to a spark plug. According to the invention, the connector portion includes a terminal, a contact assembly, and a contact spring. The terminal is electrically conductive and is connected to the transformer output. The terminal further has a base, a sidewall extending axially from the base, and a groove on an interior side of the sidewall. The contact assembly is located in the groove and includes a spring clip sandwiched between a pair of wave washers. The contact spring is disposed between the contact assembly and the interior base of the terminal. When the coil is inserted onto the spark plug, a low natural frequency connection is made via the contact assembly and contact spring.

The invention provides the benefit, from a vibration standpoint, of allowing movement of the spark plug during engine operation without applying (i.e., coupling) large forces to the ignition apparatus, thereby suppressing excitation of undesirable resonances within the ignition apparatus.

### BRIEF DESCRIPTION OF THE DRAWINGS

The present invention will now be described by way of example, with reference to the accompanying drawings.

FIG. 1 is a simplified schematic and block diagram view of an ignition apparatus having an improved high voltage connection according to the invention.

FIG. 2 is an exploded, perspective view showing, in greater detail, the high voltage connection of FIG. 1.

FIG. 3 is a simplified, plan view of a spring clip shown in FIG. 2.

FIG. 4 is a simplified cross-sectional view showing the connection of FIG. 2 as engaged onto a spark plug.

### DETAILED DESCRIPTION OF THE PREFERRED EMBODIMENTS

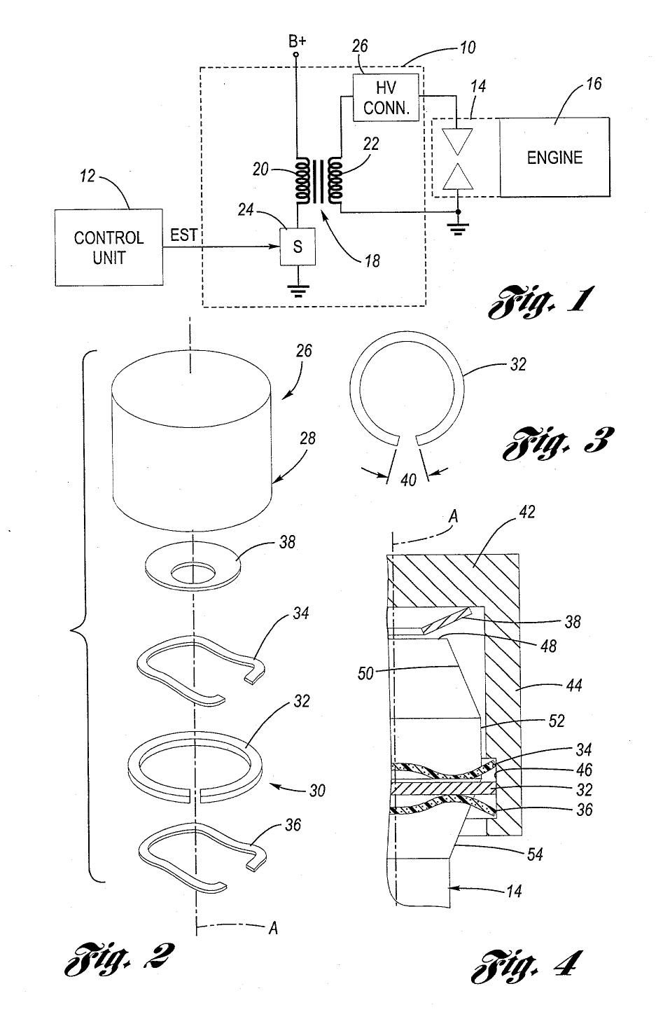

Referring now to the drawings wherein like reference numerals are used to identify identical components in the various views, FIG. 1 illustrates an ignition apparatus 10 according to the invention. Ignition apparatus 10 may be coupled to, for example, a control unit 12, which may contain primary energization control circuitry for controlling the charging and discharging of ignition apparatus 10. The relatively high voltage produced by ignition apparatus 10 is provided to a spark plug 14 for producing a spark across a spark gap thereof, and which may be employed to initiate combustion in a combustion chamber of an internal combustion engine 16.

Ignition apparatus 10 is adapted for installation to a conventional internal combustion engine through a spark plug well onto a high voltage terminal of the spark plug, which in turn may be retained by a threaded engagement with a spark plug opening in the above-described combustion cylinder. Although not shown, apparatus 10 therefore has a relatively slender profile-configured for this purpose (i.e., it is a “pencil” coil in a preferred embodiment). The engine may provide power for locomotion of a self-propelled vehicle, such as an automotive vehicle.

Control unit 12, as known, is configured to generate an electronic spark timing (EST) signal that determines when charging is to commence (i.e., when the EST signal transitions from a logic low, to a logic high state), the duration of charging (i.e., how long the EST signal is asserted), and when the spark is to occur (i.e., when the EST signal transitions from a logic high to a logic low).

Ignition apparatus 10 includes a transformer portion 18 comprising a core, a primary winding 20, and a secondary winding 22. Apparatus 10 further includes a switch 24 (in one embodiment) and a high voltage connection 26 according to the invention.

Transformer portion 18 is configured generally to produce a spark voltage on an output thereof, which may be coupled to spark plug 14 to generate a spark for initiating combustion, as known. In the illustrated embodiment, the transformer output comprises a high voltage end of secondary winding 22, or a metal conductor or the like (not shown) located proximate thereto and connected to the high voltage end of the secondary winding. Transformer portion 18 is configured to be connected to a power source, such as a vehicle battery, designated B+ in FIG. 1, which may be nominally 12 volts, or alternatively, 42 volts. Transformer portion 18 may comprise conventional components known to those of ordinary skill in the art.

Switch 24 is configured to effect charging and discharging of apparatus 10 responsive to the EST signal described above. As understood by those of ordinary skill in the art, switch 24 is operative to connect the low side of primary winding 20 to ground, thereby allowing a primary current to begin to flow therethrough. When switch 24 is opened according to the EST signal, the flow of primary current is interrupted, which, as also known, produces a relatively high voltage (i.e., the spark voltage) to be generated on the high voltage end of the secondary winding. While switch 24 is shown as being included with apparatus 10, it should be understood that in alternate embodiments, switch 24 may be located in a module separate from apparatus 10. Switch 24 may comprise conventional switching components (i.e., IGFET, MOSFET, bipolar transistor, or the like).

High voltage connector 26 is configured to couple the relatively high spark voltage produced on the output of transformer 18 to spark plug 14. Connector 26 is characterized as having a relatively low stiffness, which in combination with the total mass, provides a low natural frequency thereby mechanically isolating the ignition apparatus 10 from the spark plug 14. In the illustrated embodiment to be described below, this isolation is realized by using a series of springs.

FIG. 2 is a perspective, exploded view of connector 26. Connector 26 includes a terminal 28, a contact assembly 30 comprising a spring clip 32 sandwiched between a pair (first and second) of opposing springs, such as wave washers 34, 36, and a contact spring 38. Clip 32 includes a gap 40 (best shown in FIG. 3) to be described below.

Terminal 28, in the illustrated embodiment, is formed of electrically conductive material (e.g., metal) and provides a housing for the series of springs 32, 34, 36 and 38. Springs 34, 36 could take different spring forms, such as crest-to-crest washers, single-waved washers, or single-waved spring wires (i.e., round in cross-section vs. rectangular). Additionally, spring 32 could take the form of a spring wire as well. Terminal 28 has a main axis associated therewith, designated “A” in FIG. 2.

As best shown in FIG. 4, terminal 28 further includes a base portion 42, from which extends a generally annular sidewall 44. Terminal 28 may include a post or other extension (not shown) to which the high voltage end of secondary winding 22 is attached. Alternatively, an intermediate structure (not shown) may be provided so as to electrically couple terminal 28 to the high voltage end of secondary winding 22. As shown in FIG. 4, terminal 28 further includes a circumferentially-extending groove 46 formed on an inner surface of sidewall 44.

The high voltage terminal on spark plug 14, in a typical/conventional case, includes a generally planar top first surface 48, an annular, radially-outwardly tapering second surface 50 extending from surface 48, an annular, cylindrical-shaped third surface 52 extending from surface 50, and an annular, radially-inwardly tapering fourth surface 54 extending from surface 52.

Spring 32 is provided with gap 40 (best shown in FIG. 3) configured to allow spring 32 to expand and contract radially for at least two purposes. The first purposes relates to initial assembly. The spring clip 32 has an outside diameter that, in an unstressed state, is larger than the inside diameter of the sidewall 44 of terminal 32. Therefore, in order to insert spring clip into terminal 28 (specifically into groove 46), it must first be compressed (radially reduced). The gap 40 allows for compression, temporarily permitting a reduction in the outside diameter of the spring clip. The second reason relates to the time when the spark plug is inserted into connector 26. In that instance, it should be appreciated that spring clip 32 has an inside diameter that, in an unstressed state, is less than the outside diameter of surface 52 of spark plug 14, and, optionally, a portion of the tapered surfaces 50 and 54 that are adjacent to surface 52. Thus, in order for the high voltage terminal of plug 14 to be inserted into connector 26, spring clip 32 must pass over the tapered and side surfaces 50, 52 to rest engaged against tapered surface 54. Gap 40 allows for this expansion/contraction. Spring 32 may comprise electrically conductive material. Spring 32 does not contribute in any meaningful way to the axial spring rate of the combination of springs 32, 34, 36 and 38, since its spring force is principally radial in nature. The main purpose of spring 32 is to axially retain transformer 10 to spark plug 14.

Springs 34 and 36 may be wave washers, which conventionally may have three to four waves formed around its circumference. Springs 34 and 36 have a relatively low spring rate relative to the mass of ignition coil 10, but may become very stiff when flattened out. An outside diameter of springs 34 and 36 is, in the illustrated embodiment, larger than the inside diameter of the sidewall 44 but less than the diameter of groove 46. This allow the springs 34, 36 to be retained in groove 46 after initial assembly of contact assembly 30.

Spring 38 defines the primary electrical contact between terminal 28 and spark plug 14. In the illustrated embodiment, spring 38 comprises a Belleville type spring, i.e., one that is conical in shape. However, other spring types could be substituted. Spring 38 preferably is characterized by a low spring rate, relative to the mass of the ignition coil 10.

The spring rates referred to above may assume a range of specific values. Overall, however, certain criteria should be met. First, the overall natural frequency of the combination of springs 32, 34, 36 and 38 should be relatively low for vibration isolation. For example, the lowest natural frequency should be less than or equal to about 60% of the lowest firing frequency of the engine under consideration (i.e., onto which the ignition coil 10 is installed). The frequency thus, depending on the number of cylinders in the engine, may below about 10 Hz in one embodiment. In addition, spring 32 should be selected so as to avoid requiring excessive force to remove the ignition coil 10 from the spark plug. In one embodiment, a removal force may be within a range of about 5-10 pounds.

In operation, as the ignition coil 10 is inserted on the spark plug 14, spring 34 is flattened out, and spring 32 is forced to expand radially so that it will slip over the tapered and side surfaces 50, 52 of spark plug 14, and engage lower tapered surface 54. When the insertion force is relaxed, neither wave washers 34, 36 are completely flat and the overall axial spring rate is relatively low, thereby allowing movement of the plug top while only minimally applying a force to the ignition coil 10 itself. Contact spring 38 provides an additional electrical contact, and further provides an axial force (downward).

When the spark plug 14 is removed, an upward axial force is applied to ignition coil 10, which will flatten spring 36. At this point, spring 32 will be forced radially open to slip over the top of the spark plug over surfaces 54, 52 and 50, in sequence.

A benefit, from a vibration isolation standpoint, of the present invention is that the spark plug can move/vibrate slightly during engine operation without applying large forces to the ignition coil 10, thereby preventing the excitation of undesirable resonances within the ignition coil 10.

1. An ignition apparatus comprising:
a transformer coupled to power source for producing a spark voltage on an output thereof, and
a connector configured to couple said spark voltage to a spark plug, said connector including:
a terminal having an annular sidewall extending from a base, said terminal connected to said transformer output, said terminal further having an annular groove on an interior side of said sidewall;
a contact assembly in said groove including a spring clip sandwiched between first and second wave washers;
a contact spring between said contact assembly and said base.

2. The ignition apparatus of claim 1 wherein said terminal has a main axis associated therewith, said annular sidewall having a first inside diameter, said groove having a second inside diameter that is greater than said first inside diameter.

3. The ignition apparatus of claim 2 wherein said spring clip comprises an annular strip having a third inside diameter in an unstressed state that is less than an outside diameter associated with a connection terminal of said spark plug, said spring clip further including a gap configured to allow said spring clip to expand for maintaining engagement with said connection terminal.

4. The ignition apparatus of claim 1 wherein said contact spring comprises a cone-shaped washer.

5. An ignition apparatus comprising:
a transformer coupled to power source for producing a spark voltage on an output thereof; and
a connector configured to couple said spark voltage to a spark plug, said connector including:
a terminal of electrically conductive material having a main axis associated therewith, said terminal further having an annular sidewall axially extending from a base, said terminal connected to said transformer output, said terminal further having an annular groove on an interior side of said sidewall, said annular sidewall having a first inside diameter, said groove having a second inside diameter that is greater than said first inside diameter;
a contact assembly in said groove including a metal spring clip sandwiched between first and second metal wave washers;
a metal contact spring between said contact assembly and said base.

6. The ignition apparatus of claim 5 wherein said spring clip comprises an annular strip having a third inside diameter in an unstressed state that is less than an outside diameter associated with a connection terminal of said spark plug, said spring clip further including a gap configured to allow said spring clip to expand for maintaining engagement with said connection terminal.

7. The ignition apparatus of claim 6 wherein said contact spring comprises a cone-shaped washer.
